(19) United States
(12) Patent Application Publication
(10) Pub. No.: US 2026/0249738 A1
(43) Pub. Date: Aug. 27, 2026

(54) CONTROL DEVICE, CONTROL METHOD, AND STORAGE MEDIUM

(71) Applicant: HONDA MOTOR CO., LTD., Tokyo (JP)

(72) Inventors: Shoichi KOBAYASHI, Tokyo (JP); Kazuki YAMANO, Tokyo (JP); Yuki HARA, Tokyo (JP)

(73) Assignee: HONDA MOTOR CO., LTD., Tokyo (JP)

(21) Appl. No.: 19/535,456

(22) Filed: Feb. 10, 2026

(30) Foreign Application Priority Data
Feb. 25, 2025 (JP) 2025-027849

(51) Int. Cl. B60L 53/68; B60L 53/62; B60L 53/66; G07C 5/00

(52) U.S. Cl. CPC B60L 53/68; B60L 53/62; B60L 53/66; G07C 5/008; B60L 2240/12; B60L 2240/70

(57) ABSTRACT

A control device to control a vehicle that includes a motor, a battery, and a communication interface communicable with a server includes a processor and a memory. The processor is configured to acquire external environment information around the vehicle, the memory is configured to store the external environment information, and the processor is configured to determine, when the vehicle is parked, whether to transmit the external environment information to the server based on a remaining power amount of the battery, and to control the communication interface based on a result of the determination to transmit the external environment information to the server. The processor transmits the external environment information to the server when the remaining power amount is equal to or greater than a threshold, and does not transmit the external environment information to the server when the remaining power amount is less than the threshold.

This application is based on and claims priority under 35 USC 119 from Japanese Patent Application No. 2025-027849 filed on February 25, 2025, the entire content of which is incorporated herein by reference.

### TECHNICAL FIELD

The present disclosure relates to a control device, a control method, and a non-transitory computer-readable storage medium.

### BACKGROUND ART

In recent years, improvements in traffic safety have been required to enable inclusion, safety, toughness, and sustainability of urban and human residents. From the viewpoint of improving the traffic safety, for example, development of a driving assistance technique and an autonomous driving technique for vehicles has been advanced. In addition, in recent years, efforts to realize a low-carbon society or a decarbonized society become active, and it is required to reduce CO₂ emission and improve energy efficiency also in vehicles such as automobiles. From the viewpoint of reducing the CO₂ emission, development of electric vehicles such as an electric automobile (electrical vehicle) using a motor (that is, an electric motor) as a drive source has been advanced.

JP2023-002214A below discloses a technique in which a vehicle-mounted device connected to various sensors of a vehicle uploads information obtained from the various sensors, video captured by a drive recorder, and the like to a server device at a predetermined timing.

### SUMMARY OF INVENTION

However, in the related art, in a vehicle including a motor that is a drive source and a battery that supplies power to the motor, there is room for improvement from the viewpoint of enabling uploading to a server while securing power in the battery to such an extent that the vehicle can travel.

Aspects of non-limiting embodiments of the present disclosure relates to a control device, a control method, and a non-transitory computer-readable storage medium storing a program that enable, in a vehicle including a motor that is a drive source and a battery that supplies power to the motor, uploading to a server while securing power in the battery to such an extent that the vehicle can travel.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided a control device to control a vehicle that includes a motor as a driving source, a battery to supply power to the motor, and a communication interface communicable with an external server, the control device including a processor and a memory, in which the processor is configured to acquire external environment information around the vehicle, the memory is configured to store the external environment information acquired by the processor, and the processor is configured to determine, when the vehicle is parked, whether to transmit the external environment information stored in the memory to the external server based on a remaining power amount of the battery, and to control the communication interface based on a result of the determination to transmit the external environment information to the external server, and in which the processor transmits the external environment information to the external server when the remaining power amount is equal to or greater than a threshold, and does not transmit the external environment information to the external server when the remaining power amount is less than the threshold.

According to an aspect of the present disclosure, there is provided a control method for a computer to control a vehicle that includes a motor as a driving source, a battery to supply power to the motor, and a communication interface communicable with an external server, including acquiring external environment information around the vehicle, storing the acquired external environment information in a memory, and determining, when the vehicle is parked, whether to transmit the external environment information stored in the memory to the external server based on a remaining power amount of the battery, and transmitting the external environment information to the external server by controlling the communication interface based on a result of the determination to, in which the external environment information is transmitted to the external server when the remaining power amount is equal to or greater than a threshold, and the external environment information is not transmitted to the external server when the remaining power amount is less than the threshold.

According to an aspect of the present disclosure, there is provided a non-transitory computer-readable storage medium storing a program causing a computer to perform processing, the computer configured to control a vehicle that includes a motor as a driving source, a battery to supply power to the motor, and a communication interface communicable with an external server, the processing including acquiring external environment information around the vehicle, storing the acquired external environment information in a memory, and determining, when the vehicle is parked, whether to transmit the external environment information stored in the memory to the external server based on a remaining power amount of the battery, and transmitting the external environment information to the external server by controlling the communication interface based on a result of the determination to, in which the external environment information is transmitted to the external server when the remaining power amount is equal to or greater than a threshold, and the external environment information is not transmitted to the external server when the remaining power amount is less than the threshold.

According to an aspect of the present disclosure, it is possible to provide a control device, a control method, and a non-transitory computer-readable storage medium storing a program that enable, in a vehicle including a motor that is a drive source and a battery that supplies power to the motor, uploading to a server while securing power in the battery to such an extent that a vehicle can travel. This hence contributes to development of a sustainable transportation system.

### BRIEF DESCRIPTION OF DRAWINGS

Exemplary embodiment(s) of the present invention will be described in detail based on the following figures, wherein:

FIG. 1 is a schematic configuration diagram of a vehicle 100;

FIG. 2 is a block diagram showing a configuration example of the vehicle 100;

FIG. 3 shows an example of schedule information TC;

FIG. 4 shows an example of transmission information TD;

FIG. 5 shows examples of a threshold Th for a remaining power amount of a battery BAT;

FIG. 6 shows an example of a predetermined time T;

FIG. 7 is a flowchart (part 1) showing an example of processing performed by a control device 30 of the vehicle 100;

FIG. 8 is a flowchart (part 2) showing the example of the processing performed by the control device 30 of the vehicle 100.

### DESCRIPTION OF EMBODIMENTS

Hereinafter, exemplary embodiments of a control device, a control method, and a non-transitory computer-readable storage medium of the present disclosure will be described in detail with reference to the drawings. The drawings are viewed in directions of reference signs. The following embodiments does not limit the present invention, and not all of elements described in the following embodiments are essential to the present invention. Hereinafter, the same or similar elements are denoted by the same or similar reference signs, and descriptions thereof may be omitted or simplified.

### 1. Vehicle

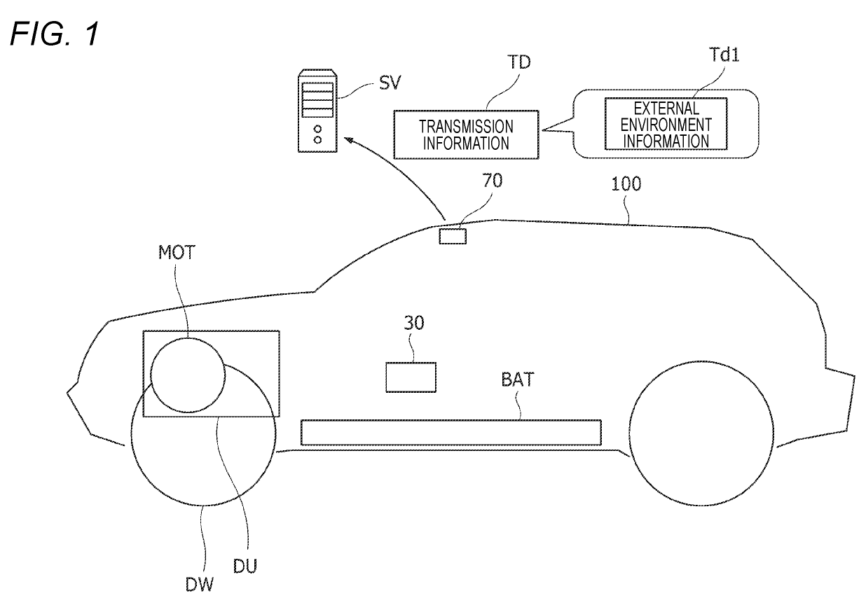

As shown in FIG. 1, a vehicle 100 of an exemplary embodiment is an electric vehicle including: a drive device DU including a motor MOT as a drive source; a battery BAT that supplies power to the motor MOT; a communication interface 70 communicable with an external server SV; and a control device 30 as an example of the control device of the exemplary embodiment. The vehicle 100 travels by the motor MOT which uses the power supplied from the battery to drive drive wheels DW of the vehicle 100.

The server SV is a computer provided in a data center or the like, and is managed by, for example, a manufacturer of the vehicle 100. The server SV may be a physical server implemented as one device or may be a virtual server (so-called cloud server) implemented in a cloud computing service.

The vehicle 100 and the server SV can communicate with each other via a mobile communication network such as so-called "4G" or "5G", or a wireless communication network such as Wi-Fi (registered trademark), Bluetooth (registered trademark), Bluetooth Low Energy (BLE, registered trademark), or Low Power Wide Area (LPWA). Then, the vehicle 100 transmits predetermined transmission information TD to the server SV by the communication interface 70 at a predetermined timing.

The transmission information TD includes, for example, external environment information Td1 for recognizing a periphery (in other words, surroundings) of the vehicle 100. Accordingly, the server SV can recognize (in other words, grasp) the periphery of the vehicle 100 based on the transmission information TD received from the vehicle 100. As an example, based on the transmission information TD received from the vehicle 100 traveling in a predetermined parking lot, the server SV can recognize a state (for example, occupancy and availability) of the parking lot. In this case, for example, the server SV can distribute information indicating the state of the parking lot to a vehicle scheduled to enter the parking lot (for example, another vehicle other than the vehicle 100).

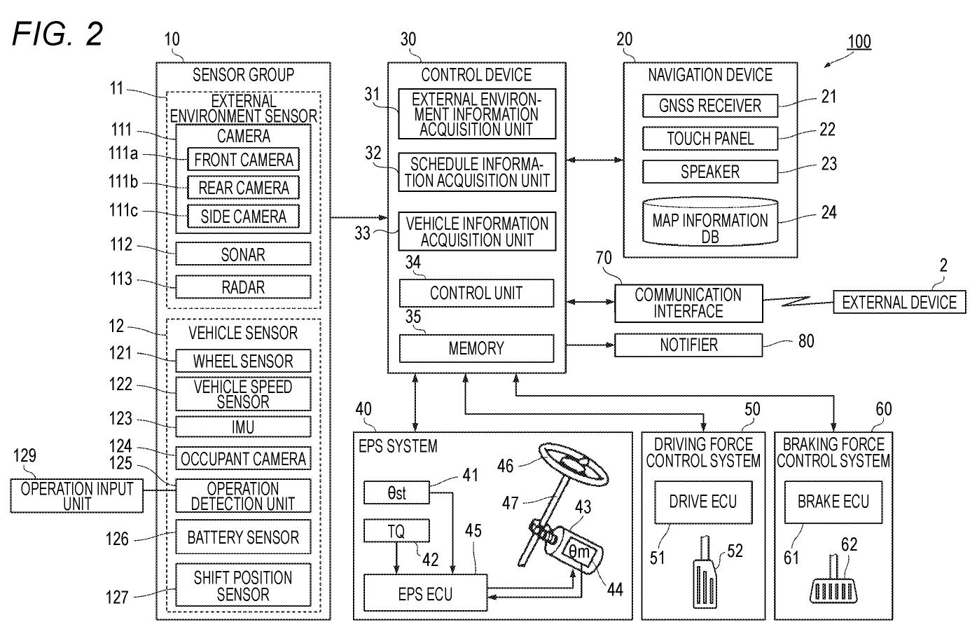

As shown in FIG. 2, the vehicle 100 includes, for example, a sensor group 10, a navigation device 20, the control device 30, an electric power steering (EPS) system 40, a driving force control system 50, a braking force control system 60, the communication interface 70, and a notifier 80.

The sensor group 10 includes an external environment sensor 11 that acquires the external environment information Td1 for recognizing the periphery (in other words, surroundings) of the vehicle 100, and a vehicle sensor 12 that acquires information Td2 on the vehicle 100 (hereinafter, also referred to as "vehicle information"). The information acquired by each sensor in the sensor group 10 is output to the control device 30 and used for controlling the vehicle 100 by the control device 30 and the like.

The external environment sensor 11 includes, for example, a camera 111, a sonar 112, and a radar 113. The camera 111 captures an image of the periphery of the vehicle 100 including a front side of the vehicle 100, and outputs image data of an obtained peripheral image to the control device 30. Such image data is an example of the external environment information Td1. As the camera 111, for example, a digital camera using an imaging element such as a charge coupled device (CCD) or a complementary metal oxide semiconductor (CMOS) can be adopted.

More specifically, the camera 111 includes, for example, a front camera 111a, a rear camera 111b, and side cameras 111c. The front camera 111a is provided, for example, on an upper portion of a front windshield or a front grille (not shown) of the vehicle 100, and captures an image of a scene in front of the vehicle 100. The rear camera 111b is provided, for example, near a license plate (in other words, an automobile registration number mark) attached to a rear portion of the vehicle 100, and captures an image of a scene behind the vehicle 100. The side cameras 111c are provided, for example, on left and right side mirrors (not shown), and capture images of scenes on lateral sides (that is, left and right sides) of the vehicle 100.

The sonar 112 emits sound waves to the periphery of the vehicle 100 (for example, the front side, the rear side, and the lateral sides of the vehicle 100), and receives reflected sounds from an object present in the periphery of the vehicle 100, thereby detecting a distance to the object from the vehicle 100, an azimuth, and the like, and outputting a detection result thereof to the control device 30. The detection result from the sonar 112 is another example of the external environment information Td1.

The radar 113 emits radio waves to the periphery of the vehicle 100 including the front side of the vehicle 100, and receives reflected waves from an object present in the periphery of the vehicle 100, thereby detecting a distance to the object, an azimuth, and the like. As the radar 113, for example, a millimeter wave radar can be adopted. A detection result from the radar 113 is another example of the external environment information Td1.

The external environment sensor 11 may include light detection and ranging (LiDAR) instead of or in addition to the sonar 112 and the radar 113. In this case, the LiDAR emits laser light to the periphery of the vehicle 100 including the front side of the vehicle 100, and receives reflected light from an object present in the periphery of the vehicle 100, thereby detecting a distance to the object from the vehicle 100, an azimuth, and the like.

The external environment information Td1 may be information indicating a recognition result of the periphery of the vehicle 100 obtained by sensor fusion of information obtained by two or more sensors among the camera 111, the sonar 112, the radar 113, and the LiDAR. The external environment information Td1 may also be information indicating an environmental map of the periphery of the vehicle 100 generated by simultaneous localization and mapping (SLAM) using information obtained by the external environment sensor 11, the vehicle sensor 12 to be described later, and the like.

The vehicle sensor 12 includes, for example, a wheel sensor 121, a vehicle speed sensor 122, an inertial measurement unit (IMU) 123, an occupant camera 124, an operation detection unit 125, a battery sensor 126, and a shift position sensor 127.

The wheel sensor 121 detects a rotation angle of one or a plurality of wheels among wheels of the vehicle 100. As an example, the wheel sensor 121 detects a rotation angle of each of a left rear wheel and a right rear wheel. As the wheel sensor 121, for example, an angle sensor or a displacement sensor can be adopted.

The vehicle speed sensor 122 detects a vehicle speed VP that is a travel speed of the vehicle 100 (in other words, a movement speed of a vehicle body). For example, the vehicle speed sensor 122 detects the vehicle speed VP based on a rotation speed of a counter shaft (not shown) provided in the vehicle 100.

The inertial measurement unit 123 detects angular velocities of the vehicle 100 in a pitch direction, a roll direction, and a yaw direction, and accelerations of the vehicle 100 in a front-rear direction, a left-right direction, and an upper-lower direction. The vehicle sensor 12 may include, instead of the inertial measurement unit 123, an acceleration sensor that detects an acceleration of the vehicle 100 in a predetermined direction or a gyro sensor that detects an angular velocity of the vehicle 100 in a predetermined direction.

The occupant camera 124 is a digital camera that captures an image of the inside of the vehicle 100 and outputs image data of an obtained in-vehicle image to the control device 30. For example, the occupant camera 124 can be a so-called "driver monitor camera" that can capture an image of a head of an occupant seated in a driver seat of the vehicle 100 (for example, a user driving the vehicle 100, hereinafter simply referred to as "user") from the front. As the occupant camera 124, a digital camera using an imaging element such as a CCD or a CMOS can be adopted, similarly to the camera 111.

The operation detection unit 125 detects an operation performed using an operation input unit 129 operable by the user. The operation input unit 129 may include a switch, a button, and the like for receiving various operations.

The battery sensor 126 is a sensor for acquiring information on the battery BAT, and detects, for example, a charge or discharge current, a charge or discharge voltage, and a temperature of the battery BAT. For example, the control device 30 can estimate a remaining power amount of the battery BAT based on the information on the battery BAT acquired via the battery sensor 126.

The shift position sensor 127 detects, for example, whether a shift position of a shift lever (not shown) provided in the vehicle 100 is any one of "P (parking)", "R (reverse)", "N (neutral)", and "D (drive)". When the vehicle 100 may take another shift position (for example, "B (brake)") other than the "P", the "R", the "N", and the "D", the shift position sensor 127 may also detect whether the shift position is the other shift position.

The navigation device 20 includes, for example, a global navigation satellite system (GNSS) receiver 21, a touch panel 22, and a speaker 23. The navigation device 20 also includes a memory (not shown) implemented by a flash memory or the like. The memory of the navigation device 20 stores a map information database (DB) 24 and the like.

The map information database 24 includes road network information. The road network information is information representing roads based on a combination of nodes and links connecting the nodes (also referred to as "paths"). Each of the nodes in the road network information represents, for example, a feature on a road such as an intersection, a corner, or a dead end. In the road network information, for each of the nodes, for example, information indicating a location corresponding to the node (for example, coordinates that enable specifying one location on a map such as a latitude and a longitude) is set. Further, in the road network information, for each of the links, information indicating nodes at both ends of the link, a road corresponding to the link, a link length, a lane number, a traveling direction, a road type, and the like is set.

The GNSS receiver 21 specifies a current position of the vehicle 100 (for example, a latitude and a longitude of a location where the vehicle 100 is located) based on a signal received from a GNSS satellite. For example, the navigation device 20 may acquire a detection result from the vehicle sensor 12 (for example, the wheel sensor 121 or the vehicle speed sensor 122) via the control device 30, and specify or complement the current position of the vehicle 100 by an inertial navigation system (INS) using a detection value from the vehicle sensor 12.

For example, the touch panel 22 is implemented by combining a display device such as a liquid crystal display or an organic light emitting diode (OLED) with a pointing device (for example, a touch pad). The speaker 23 can output a sound to the occupant of the vehicle 100 including the user. The touch panel 22 is an example of the notifier 80 that can issue a notification to the user. The speaker 23 is another example of the notifier 80 that can issue a notification to the user.

For example, the navigation device 20 searches for, by referring to the map information database 24, a route from the current position of the vehicle 100 to a destination set by the user using the touch panel 22. Then, the navigation device 20 performs route guidance using the touch panel 22 and the speaker 23 based on the found route.

When a waypoint is set by the user using the touch panel 22, the navigation device 20 may search for a route to the destination via the waypoint. Further, in consideration of the remaining power amount of the battery BAT and the like, the navigation device 20 may automatically set, as the waypoint, a predetermined power-supply-enabled location where power can be supplied to the battery BAT. An example of the power-supply-enabled location is a charging stand (also referred to as a "charging station") provided with a power supply facility (for example, a so-called "charging gun") that can supply power to the vehicle 100.

The navigation device 20 may also cause the touch panel 22 to perform a predetermined display according to an instruction from the control device 30. Further, the navigation device 20 may output predetermined information (for example, information indicating an operation received via the touch panel 22) to the control device 30.

The control device 30 is a computer that integrally controls the entire vehicle 100, and is implemented, for example, by one electronic control unit (ECU) or by a plurality of ECUs working in cooperation with each other.

The EPS system 40 includes, for example, a steering angle sensor 41, a torque sensor 42, an EPS motor 43, a resolver 44, and an EPS ECU 45.

The steering angle sensor 41 detects a steering angle θst of a steering 46 and outputs information indicating the detected steering angle θst to the EPS ECU 45. The torque sensor 42 detects a steering torque TQ, which is a torque applied to the steering 46 of the vehicle 100, and outputs information indicating the detected steering torque TQ to the EPS ECU 45.

The EPS motor 43 assists the user in operating the steering 46 by applying, according to an instruction from the EPS ECU 45, a driving force or a reaction force to a steering column 47 coupled to the steering 46. The resolver 44 detects a rotation angle θm of the EPS motor 43 and outputs information indicating the detected rotation angle θm to the EPS ECU 45.

The EPS ECU 45 is a computer that includes, for example, a processor that performs various calculations, a memory including a non-transitory storage medium for storing various types of information, and an input and output unit that controls input and output of data between the inside and the outside of the EPS ECU 45 (all of which are not shown), and controls the EPS system 40 (for example, the EPS motor 43). The EPS ECU 45 is implemented by one or two or more ECUs. For example, the EPS ECU 45 controls the EPS system 40 (for example, the EPS motor 43) based on the steering angle θst detected by the steering angle sensor 41, the steering torque TQ detected by the torque sensor 42, and the rotation angle θm detected by the resolver 44. The EPS ECU 45 can also control the EPS system 40 according to an instruction from the control device 30.

The EPS system 40 (for example, the EPS ECU 45) may output, to the control device 30, information indicating the steering angle θst detected by the steering angle sensor 41, the steering torque TQ detected by the torque sensor 42, the rotation angle θm detected by the resolver 44, and the like. Further, the EPS system 40 (for example, the EPS ECU 45) may output information indicating a steering speed ω of the steering 46 to the control device 30. In this case, the steering speed ω is obtained by, for example, differentiating the steering angle θst with respect to time.

The driving force control system 50 includes a drive ECU 51 and can control a driving force of the vehicle 100. The drive ECU 51 is a computer that includes, for example, a processor that performs various calculations, a memory including a non-transitory storage medium for storing various types of information, and an input and output unit that controls input and output of data between the inside and the outside of the drive ECU 51 (all of which are not shown), and controls the driving force control system 50. The drive ECU 51 is implemented by one or a plurality of ECUs. For example, the drive ECU 51 controls power output from the drive source of the vehicle 100 (for example, the motor MOT), based on an operation on an accelerator pedal 52 provided in the vehicle 100. The drive ECU 51 can also control the driving force control system 50 (for example, the drive source) according to an instruction from the control device 30.

The braking force control system 60 includes a brake ECU 61 and can control a braking force of the vehicle 100. The brake ECU 61 is a computer that includes, for example, a processor that performs various calculations, a memory including a non-transitory storage medium that stores various types of information, and an input and output unit that controls input and output of data between the inside and the outside of the brake ECU 61 (all of which are not shown), and controls the braking force control system 60. The brake ECU 61 is implemented by one or a plurality of ECUs. For example, the brake ECU 61 controls the braking force of the vehicle 100 by controlling a brake device (not shown) provided in the vehicle 100, based on an operation on a brake pedal 62 provided in the vehicle 100. Here, the brake device includes, for example, a brake caliper, a cylinder that transmits a hydraulic pressure to the brake caliper, and an electric motor that generates the hydraulic pressure in the cylinder. The brake ECU 61 controls the electric motor of the brake device such that a braking force corresponding to the operation on the brake pedal 62 is generated. The brake ECU 61 can also control the braking force control system 60 (for example, the brake device) according to an instruction from the control device 30.

The communication interface 70 is a communication interface that communicates with an external device 2 under control by the control device 30. The control device 30 can communicate with the external device 2 via the communication interface 70. Examples of the external device 2 include the server SV described above and a terminal device (for example, a smartphone) of the user. As described above, for example, a mobile communication network, WI-FI, Bluetooth, BLE, or LPWA can be used for the communication between the vehicle 100 and the external device 2.

The notifier 80 is a user interface that issues a notification to the user under control by the control device 30. The notifier 80 may include, for example, a display device such as a liquid crystal display or an OLED, or may include a lamp (in other words, a light-emitting device) including a light-emitting element (for example, an LED) that can emit light in a predetermined emission color. In addition, the notifier 80 is not limited to being visually recognizable from the inside of the vehicle 100, and may include a notifier visually recognizable from the periphery of the vehicle 100 (that is, the outside of the vehicle). An example of the notifier 80 visually recognizable from the outside of the vehicle is a lamp provided near a charging port (not shown) of the vehicle 100 that can be connected to the above-described power supply facility (for example, the charging gun).

### 2. Control Device

The control device 30 is a computer that controls the entire vehicle 100, and is implemented by, for example, one or two or more electronic control units (ECUs). For example, the control device 30 includes a processor (not shown) that performs various calculations, a memory 35 including a non-transitory storage medium that stores various types of information (for example, programs and various types of data), and an input and output unit (not shown) as an interface that controls input and output of data between the inside and the outside of the control device 30. The control device 30 includes an external environment information acquisition unit 31, a schedule information acquisition unit 32, a vehicle information acquisition unit 33, and a control unit 34 as functional units implemented by the processor executing the programs stored in the memory 35.

The external environment information acquisition unit 31 acquires the external environment information Td1 around the vehicle 100. For example, the external environment information acquisition unit 31 can acquire the external environment information Td1 via the external environment sensor 11. The external environment information Td1 may include, for example, information indicating positions of division lines (for example, white lines), parking spaces, obstacles, and other vehicles present around the vehicle 100. The external environment information Td1 may also include, for example, information indicating a road surface state (for example, dry or wet) around the vehicle 100.

The schedule information acquisition unit 32 acquires schedule information TC on a travel schedule of the vehicle 100. For example, the schedule information acquisition unit 32 can acquire the schedule information TC from the navigation device 20 or the terminal device of the user communicable with the vehicle 100.

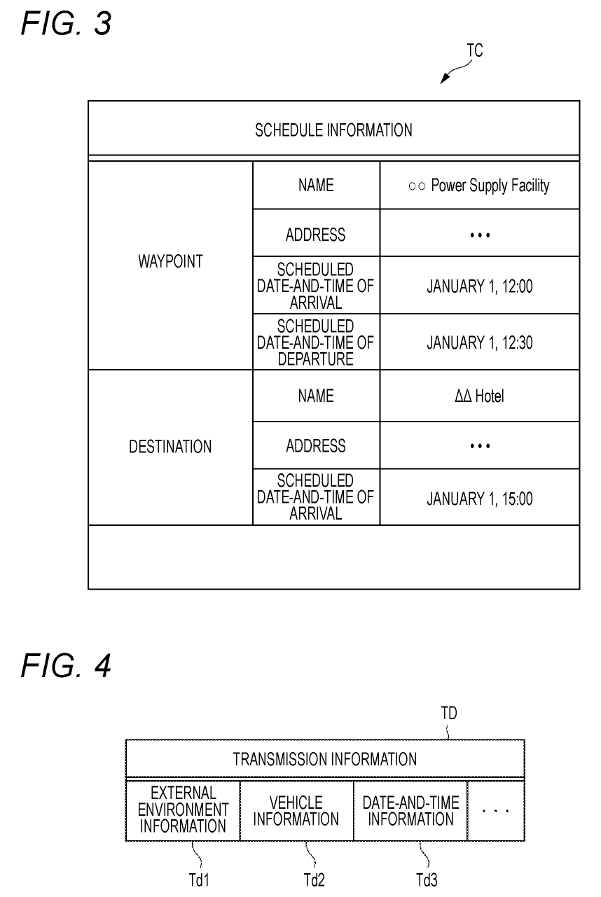

As shown in FIG. 3, the schedule information TC may include, for example, information on the waypoint and the destination of the vehicle 100. The information on the waypoint may include, for example, a name and an address of the waypoint, scheduled date-and-time of arrival at the waypoint, and scheduled date-and-time of departure from the waypoint. A time from the scheduled date-and-time of arrival at the waypoint to the scheduled date-and-time of departure can also be referred to as a scheduled stay time of the vehicle 100 at the waypoint. The information on the destination may include, for example, a name and an address of the destination, and a scheduled date-and-time of arrival at the destination.

However, the schedule information TC is not limited thereto. For example, the schedule information TC may be information indicating a schedule of the user registered in a schedule management application installed in the terminal device of the user, and may include, for example, information indicating a habitual schedule of the user for each day of the week.

The vehicle information acquisition unit 33 acquires the vehicle information Td2 on the vehicle 100. For example, the vehicle information acquisition unit 33 can acquire the vehicle information Td2 via the vehicle sensor 12 or the navigation device 20. The vehicle information Td2 may include, for example, information indicating a location where the vehicle 100 travels, and the steering angle θst and the shift position at the location.

When the vehicle 100 is able to automatically park in the target parking position by autonomously travelling to a predetermined target parking position, the vehicle information Td2 may include information on a travel trajectory of the vehicle 100 generated for the autonomous traveling. Here, the autonomous traveling is traveling that does not depend on an operation from the user. In addition, when the vehicle 100 can perform so-called "memory parking", the vehicle information Td2 may include information on a travel trajectory along which the vehicle 100 has traveled to store information used for the memory parking. Here, the memory parking is a function of automatically parking to a predetermined target parking position by autonomously traveling to the target parking position along a stored travel trajectory. In this way, the vehicle information Td2 includes the information on the travel trajectory of the vehicle 100, and thus the transmission information TD including the information on the travel trajectory can be uploaded to the server SV.

The memory 35 stores the external environment information Td1 acquired by the external environment information acquisition unit 31, the vehicle information Td2 acquired by the vehicle information acquisition unit 33, and the like in addition to the programs described above. For example, the memory 35 stores the external environment information Td1 and the vehicle information Td2 in association with date-and-time information Td3 indicating date-and-time when such information is acquired.

When the vehicle 100 is parked, the control unit 34 determines whether to transmit the transmission information TD including the external environment information Td1 and the like stored in the memory 35 to the server SV, based on the remaining power amount of the battery BAT. Then, the control unit 34 controls the communication interface 70 based on a result of the determination to transmit the transmission information TD to the server SV. As described above, for example, the control unit 34 can estimate the remaining power amount of the battery BAT based on the information on the battery BAT acquired via the battery sensor 126.

As shown in FIG. 4, the transmission information TD includes, for example, the external environment information Td1, the vehicle information Td2, and the date-and-time information Td3. In this way, the control unit 34 uploads, to the server SV, the transmission information TD including the external environment information Td1, the vehicle information Td2, and the date-and-time information Td3, and thus the server SV can grasp the external environment information Td1, the vehicle information Td2, and the date-and-time information Td3 based on the information. However, the transmission information TD is not limited thereto. For example, the transmission information TD may be information including the external environment information Td1 and one of the vehicle information Td2 and the date-and-time information Td3.

Each piece of information in the transmission information TD may be limited to information acquired in the parking lot where the vehicle 100 has entered. In other words, the control device 30 may transmit, to the server SV, the transmission information TD that includes the external environment information Td1, the vehicle information Td2, and the like acquired in the parking lot where the vehicle 100 has entered but does not include the external environment information Td1, the vehicle information Td2, and the like acquired on a public road or the like where the vehicle 100 has traveled. In this way, it is possible to transmit, to the server SV, only the transmission information TD that enables recognition of the state of the parking lot where the vehicle 100 has entered (for example, occupancy of the parking lot). Therefore, the server SV can recognize the state of the parking lot where the vehicle 100 has entered while reducing an amount of communication between the vehicle 100 and the server SV. Hereinafter, the external environment information Td1, the vehicle information Td2, and the date-and-time information Td3 acquired in the parking lot are also collectively referred to as "parking lot information".

For example, when the remaining power amount of the battery BAT is equal to or greater than a predetermined threshold Th, the control unit 34 transmits the transmission information TD to the server SV. On the other hand, when the remaining power amount of the battery BAT is less than the threshold Th, the control unit 34 does not transmit the transmission information TD to the server SV.

In this way, by transmitting the transmission information TD to the server SV on condition that the remaining power amount of the battery BAT is equal to or greater than the threshold Th when the vehicle 100 is parked, it is possible to avoid uploading the transmission information TD (for example, the parking lot information) when the remaining power amount of the battery BAT is less than the threshold Th. Accordingly, it is possible to prevent a situation in which the vehicle 100 cannot travel as a result of a decrease in the remaining power amount of the battery BAT due to the upload of the transmission information TD. Therefore, it is possible to upload the transmission information TD to the server SV while securing power in the battery BAT to such an extent that the vehicle 100 can travel.

In a case where the remaining power amount of the battery BAT when the vehicle 100 is parked is less than the threshold Th and the transmission information TD is not uploaded, the control unit 34 may then upload the transmission information TD when the remaining power amount of the battery BAT becomes equal to or greater than the threshold Th after power is supplied to the vehicle 100 or the like.

The threshold Th may be variable according to, for example, a distance from the vehicle 100 to a predetermined location. In this case, for example, the control unit 34 may transmit the transmission information TD to the server SV when the remaining power amount of the battery BAT is equal to or greater than the threshold Th of a value estimated to allow the vehicle 100 to reach the predetermined location. Here, the predetermined location may be, for example, the destination of the vehicle 100, a home of the user, or a power supply facility (for example, a charging stand) that can supply power to the vehicle 100.

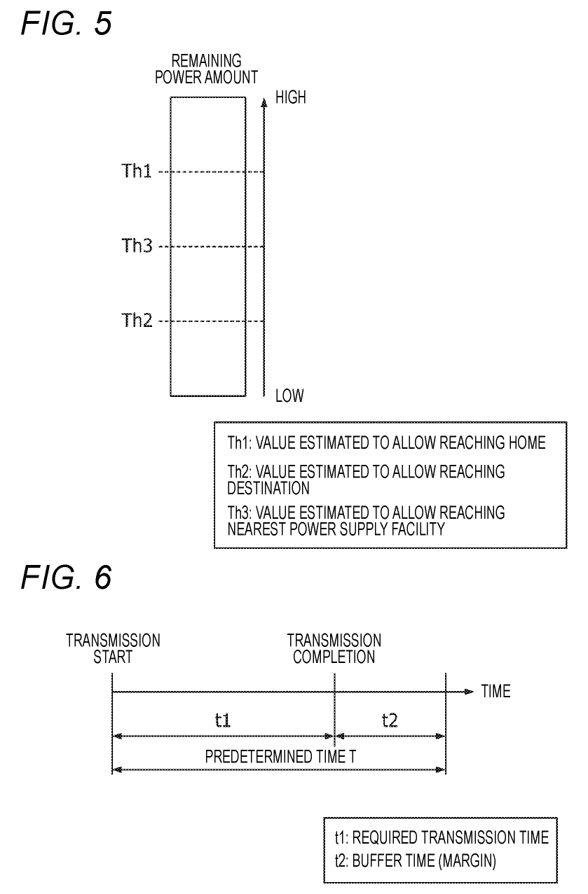

That is, as shown in FIG. 5, as the threshold Th of the remaining power amount, which is a condition for transmitting the transmission information TD to server SV, any of Th1 that is a value estimated to allow reaching the home of the user, Th2 that is a value estimated to allow reaching the destination, and Th3 that is a value estimated to allow reaching a nearest power supply facility may be adopted. For example, a smallest value among Th1, Th2, and Th3 may be adopted as the threshold Th, or a largest value may be adopted as the threshold Th.

In the example in FIG. 5, a magnitude relationship among Th1, Th2, and Th3 is Th2 < Th3 < Th1, but is not limited thereto. For example, the magnitude relationship among Th1, Th2, and Th3 may vary depending on a positional relationship between vehicle 100 and each of the home of the user, the destination, and the nearest power supply facility.

In this way, by transmitting the transmission information TD to the server SV on condition that the remaining power amount of the battery BAT is equal to or greater than the threshold Th (for example, Th1, Th2, or Th3) of the value estimated to allow the vehicle 100 to reach the predetermined location, it is possible to upload the transmission information TD to the server SV while securing power in the battery BAT to such an extent that the vehicle 100 can reach the predetermined location.

The threshold Th may be set based on the remaining power amount of the battery BAT required for the parked vehicle 100 to travel a distance for returning after uploading the transmission information TD along a route to the parking (for example, a route from the parking lot where the vehicle 100 is parked to the home of the user).

The control unit 34 may determine whether to transmit the transmission information TD to the server SV based on the remaining power amount of the battery BAT and the schedule information TC acquired by the schedule information acquisition unit 32. In this case, for example, the control unit 34 may transmit the transmission information TD to the server SV when the remaining power amount of the battery BAT is equal to or greater than the threshold Th and the vehicle 100 is estimated to be parked for a predetermined time T or longer.

As an example, it is assumed that the vehicle 100 is parked at the waypoint. In this case, the control unit 34 may transmit the transmission information TD to the server SV when the remaining power amount of the battery BAT is equal to or greater than the threshold Th and the scheduled stay time of the vehicle 100 at the waypoint is equal to or longer than the predetermined time T.

In this way, by transmitting the transmission information TD to the server SV on condition that the vehicle 100 is estimated to be parked for the predetermined time T or longer, it is possible to avoid uploading the transmission information TD when the vehicle 100 is parked for a time shorter than the predetermined time T. Therefore, it is possible to increase an opportunity to complete the upload of the transmission information TD while the vehicle 100 is parked. Therefore, it is possible to prevent occurrence of an excessive load on the vehicle 100 due to continuation of the upload of the transmission information TD even after the vehicle 100 is started.

The predetermined time T may be variable according to, for example, a data amount of the transmission information TD to be transmitted to the server SV. In this case, for example, the control unit 34 may increase the predetermined time T as the data amount of the transmission information TD to be transmitted increases. In other words, when the data amount of the transmission information TD to be transmitted is relatively large, the control unit 34 may set the predetermined time T to be longer than when the data amount is relatively small.

As an example, as shown in FIG. 6, the predetermined time T can be a time obtained by adding a predetermined buffer time t2 to a required transmission time t1 required to completely transmit the transmission information TD to be transmitted to the server SV. In this case, the required transmission time t1 is determined by the data amount of the transmission information TD to be transmitted. The buffer time t2 may be a fixed time regardless of the data amount of the transmission information TD to be transmitted, or may increase as the data amount of the transmission information TD increases.

In this way, by making the predetermined time T variable according to the data amount of the transmission information TD, it is possible to increase the opportunity to complete the upload of the transmission information TD while the vehicle 100 is parked.

If traveling of the vehicle 100 is resumed before the upload of the transmission information TD is completed, the control unit 34 may continue the upload of the transmission information TD even after the start of vehicle 100 if the remaining power amount of the battery BAT is equal to or greater than the threshold Th. Alternatively, instead of this, when the traveling of the vehicle 100 is resumed before the upload of the transmission information TD is completed, the control unit 34 may temporarily interrupt the upload of the transmission information TD in response to the start of the vehicle 100.

The parked vehicle 100 may also be connected to a power supply facility, and power may be supplied from the power supply facility to the vehicle 100. In such a case, if charging of the battery BAT with the power from the power supply facility and the upload of the transmission information TD are simultaneously performed, it may take time to charge the battery BAT due to power consumption associated with the upload of the transmission information TD.

Therefore, when the vehicle 100 is parked and connected to the power supply facility, if the remaining power amount of the battery BAT is less than the threshold Th, the control unit 34 may charge the battery BAT with the power from the power supply facility and transmit the transmission information TD to the server SV after the remaining power amount of the battery BAT becomes equal to or greater than the threshold Th.

That is, when the remaining power amount of the battery BAT is less than the threshold Th, the user may desire to recover the remaining power amount of the battery BAT as soon as possible. Therefore, in this case, the control unit 34 defers the upload of the transmission information TD until the remaining power amount of the battery BAT becomes equal to or greater than the threshold Th, and thus it is possible to reduce the power consumption due to the upload of the transmission information TD and to quickly charge the battery BAT.

When the battery BAT is charged with the power from the power supply facility and the remaining power amount of the battery BAT is less than the threshold Th, the control unit 34 may control the notifier 80 to issue a notification prompting the user to continue the supply of the power. In this way, it is possible to prevent the charging from being interrupted by the user in a state where the battery BAT is not sufficiently charged.

### 3. Processing Performed by Control Device

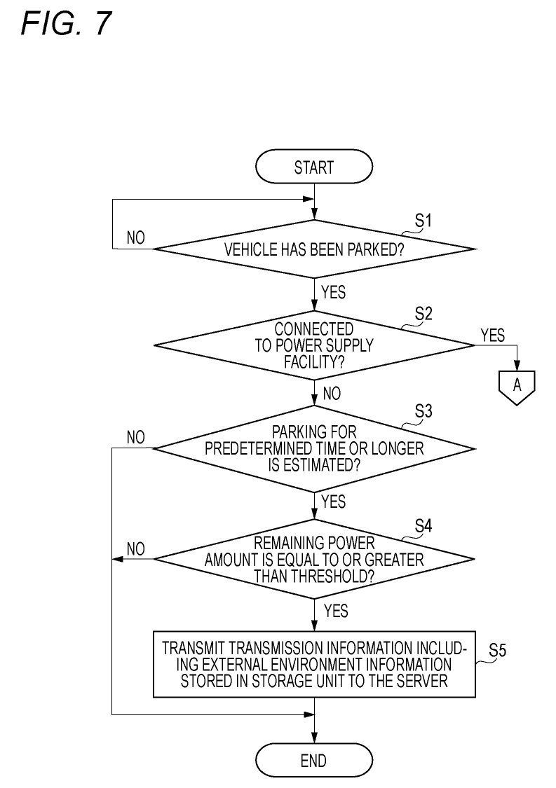

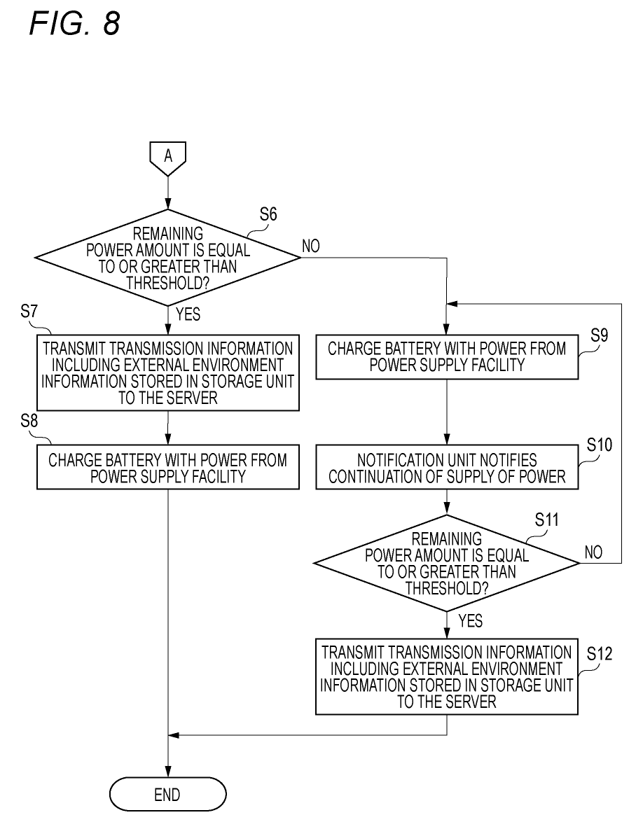

Next, an example of processing performed by the control device 30 will be described with reference to flowcharts shown in FIGS. 7 and 8.

As shown in FIG. 7, the control device 30 first determines whether the vehicle 100 is parked (step S1). In the processing of step S1, for example, the control device 30 may determine that the vehicle 100 is parked on condition that an ignition power supply of the vehicle 100 is turned off, or may determine that the vehicle 100 is parked on condition that the shift position of the vehicle 100 is set to "P". If it is determined that the vehicle 100 is not parked (step S1: NO), the control device 30 repeats the processing of step S1 until the vehicle 100 is parked.

If it is determined that the vehicle 100 is parked (step S1: YES), the control device 30 determines whether the vehicle 100 is connected to the power supply facility (step S2). In step S2, the control device 30 may determine whether the vehicle 100 is connected to the power supply facility within a predetermined time (for example, five minutes) after parking completion of the vehicle 100.

If it is determined that there is no connection to the power supply facility (step S2: NO), the control device 30 determines whether the vehicle 100 is estimated to be parked for the predetermined time T or longer (step S3).

If it is determined that the vehicle 100 is estimated to be parked for the predetermined time T or longer (step S3: YES), the control device 30 determines whether the remaining power amount of the battery BAT is equal to or greater than the threshold Th (step S4). If it is determined that the remaining power amount of the battery BAT is equal to or greater than the threshold Th (step S4: YES), the control device 30 transmits the transmission information TD including the external environment information Td1 stored in the memory 35 to the server SV (step S5), and ends the series of processing.

On the other hand, when the parking time of the vehicle 100 is estimated to be shorter than the predetermined time T (step S3: NO), or when it is determined that the remaining power amount of the battery BAT is less than the threshold Th (step S4: NO), the control device 30 ends the series of processing without transmitting the transmission information TD to the server SV.

If it is determined in the processing of step S2 that there is connection to the power supply facility (step S2: YES), as shown in FIG. 8, the control device 30 determines whether the remaining power amount of the battery BAT is equal to or greater than the threshold Th (step S6).

Then, if it is determined that the remaining power amount of the battery BAT is equal to or greater than the threshold Th (step S6: YES), the control device 30 transmits the transmission information TD including the external environment information Td1 stored in the memory 35 to the server SV (step S7), then charges the battery BAT with the power from the power supply facility (step S8), and ends the series of processing.

On the other hand, if it is determined that the remaining power amount of the battery BAT is less than the threshold Th (step S6: NO), the control device 30 starts charging the battery BAT with the power from the power supply facility (step S9) and issues a notification prompting the user to continue the supply of the power via the notifier 80 (step S10).

Then, the control device 30 determines whether the remaining power amount of the battery BAT is equal to or greater than the threshold Th (step S11). If it is determined that the remaining power amount of the battery BAT is not equal to or greater than the threshold Th (step S11: NO), the control device 30 returns to the processing of step S9.

On the other hand, if it is determined that the remaining power amount of the battery BAT is equal to or greater than the threshold Th (step S11: YES), for example, the control device 30 transmits the transmission information TD including the external environment information Td1 stored in the memory 35 to the server SV while continuing charging of the battery BAT with power from the power supply facility (step S12), and ends the series of processing.

After the processing of step S12, the connection between the vehicle 100 and the power supply facility may be disconnected, and the charging of the battery BAT may be interrupted. In this case, even when the charging of the battery BAT is interrupted, the control device 30 may continue uploading the transmission information TD as long as the remaining power amount of the battery BAT is equal to or greater than the threshold Th.

As described above, when the vehicle 100 is not connected to the power supply facility, the control device 30 transmits the transmission information TD including the external environment information Td1 to the server SV on condition that the remaining power amount of the battery BAT is equal to or greater than the threshold Th. Accordingly, it is possible to upload the transmission information TD such as the external environment information Td1 to the server SV while securing power in the battery BAT to such an extent that the vehicle 100 can reach the predetermined location such as the home of the user.

When the parking time of the vehicle 100 is estimated to be shorter than the predetermined time T or when the remaining power amount of the battery BAT is less than the threshold Th, the control device 30 does not start uploading the transmission information TD including the external environment information Td1, and thus it is possible to prevent incomplete upload to the server SV.

If the remaining power amount of the battery BAT is equal to or greater than the threshold Th when the vehicle 100 is connected to the power supply facility, the control device 30 can upload the fresh external environment information Td1 and the like to the server SV by prioritizing the upload of the transmission information TD such as the external environment information Td1 over the charging of the battery BAT. In particular, it may be important to upload the fresh external environment information Td1 or the like to the server SV, since information freshness may be important when the information include parking lot occupancy or similar data.

However, the invention is not limited thereto, and the control device 30 may upload the transmission information TD such as the external environment information Td1 and charge the battery BAT at the same time if the remaining power amount of the battery BAT is equal to or greater than the threshold Th when the vehicle 100 is connected to the power supply facility.

On the other hand, if the remaining power amount of the battery BAT is less than the threshold Th when the vehicle 100 is connected to the power supply facility, the control device 30 prioritizes the charging of the battery BAT over the upload of the transmission information TD, and thus it is possible to improve convenience for the user who desires to depart immediately after the charging of the battery BAT is completed.

As described above, according to the exemplary embodiments, in the vehicle 100 including the motor MOT that is the drive source and the battery BAT that supplies power to the motor MOT, it is possible to upload from the vehicle 100 to the server SV while securing power in the battery BAT to such an extent that the vehicle 100 can travel.

Although various embodiments have been described above with reference to the drawings, it is needless to say that the present invention is not limited to these examples. It is apparent that those skilled in the art can conceive of various modifications and alterations within the scope described in the claims, and it is understood that such modifications and alterations naturally fall within the technical scope of the present invention. In addition, the constituent elements in the above embodiment may be freely combined without departing from the gist of the invention.

The control method described in the above embodiment may be implemented by executing a program (control program) prepared in advance on a computer. For example, the present program is stored in a computer-readable storage medium and executed by being read from the storage medium. In addition, the present program may be provided in a form of being stored in a nonvolatile (non-transitory) storage medium such as a flash memory, or may be provided via a network such as the Internet.

In the present specification, at least the following matters are described. In the parentheses, the corresponding constituent elements and the like in the above embodiment are shown as examples, but the present invention is not limited thereto.

(1) A control device (control device 30) to control a vehicle (vehicle 100) that includes a motor (motor MOT) as a driving source, a battery (battery BAT) to supply power to the motor, and a communication interface (communication interface 70) communicable with an external server (external server SV), the control device including

a processor (external environment information acquisition unit 31, and control unit 34) and a memory (memory 35), in which

the processor is configured to acquire external environment information (external environment information Td1) around the vehicle,

the memory is configured to store the external environment information acquired by the processor, and

the processor is configured to determine, when the vehicle is parked, whether to transmit the external environment information stored in the memory to the external server based on a remaining power amount of the battery, and to control the communication interface based on a result of the determination to transmit the external environment information to the external server, and in which

the processor

transmits the external environment information to the external server when the remaining power amount is equal to or greater than a threshold (thresholds Th, Th1, Th2, and Th3), and

does not transmit the external environment information to the external server when the remaining power amount is less than the threshold.

According to (1), when the vehicle is parked, the external environment information is transmitted (that is, uploaded) to the external server on condition that the remaining power amount of the battery is equal to or greater than the threshold. Accordingly, it is possible to prevent occurrence of a situation in which the vehicle cannot travel since the remaining power amount of the battery decreases due to the upload of the external environment information when the remaining power amount of the battery is less than the threshold. Therefore, it is possible to upload the external environment information to the external server while securing power in the battery to such an extent that the vehicle can travel.

(2) The control device according to (1), in which

the processor (schedule information acquisition unit 32) is configured to acquire schedule information (schedule information TC) on a travel schedule of the vehicle, and in which

the processor

determines whether to transmit the external environment information to the external server based on the remaining power amount and the schedule information acquired by the processor, and

transmits the external environment information to the external server when the remaining power amount is equal to or greater than the threshold and the vehicle is estimated to be parked for a predetermined time (predetermined time T) or longer.

According to (2), the external environment information is transmitted to the external server on condition that the vehicle is estimated to be parked for the predetermined time or longer. Accordingly, it is possible to prevent the upload of the external environment information when the vehicle is parked for a time shorter than the predetermined time, and it is possible to increase an opportunity to complete the upload of the external environment information while the vehicle is parked. Therefore, it is possible to prevent occurrence of an excessive load on the vehicle due to the continuation of the upload of the external environment information even after the vehicle is started.

(3) The control device according to (2), in which

the predetermined time is variable according to a data amount of the external environment information to be transmitted to the external server, and

the processor increases the predetermined time as the data amount increases.

According to (3), it is possible to transmit the external environment information to the external server on condition that the vehicle is estimated to be parked for an appropriate time or longer in consideration of the data amount of the external environment information to be transmitted. Accordingly, it is possible to increase the opportunity to complete the upload of the external environment information while the vehicle is parked.

(4) The control device according to (1), in which

the threshold is variable according to a distance from the vehicle to a predetermined location, and

the processor transmits the external environment information to the external server when the remaining power amount is equal to or greater than the threshold that is an amount required to allow the vehicle to reach the predetermined location.

According to (4), the external environment information is transmitted to the external server on condition that the remaining power amount of the battery is equal to or greater than the threshold of the value estimated to allow the vehicle to reach the predetermined location. Accordingly, it is possible to upload to the external server while securing power in the battery to such an extent that the vehicle can reach the predetermined location.

(5) The control device according to (4), in which the predetermined location is a destination of the vehicle, a home of a user of the vehicle, or a power-suppliable location where a power supply facility enabling power to be supplied to the vehicle is provided.

According to (5), it is possible to upload to the external server while securing power in the battery to such an extent that the vehicle can reach the destination, the home of the user, or the power-supply-enabled location.

(6) The control device according to (1), in which

when the vehicle is parked and connected to a power supply facility, the processor

transmits the external environment information to the external server and then charges the battery with power from the power supply facility if the remaining power amount is equal to or greater than the threshold, and

charges the battery with the power from the power supply facility and, after the remaining power amount becomes equal to or greater than the threshold, transmits the external environment information to the external server if the remaining power amount is less than the threshold.

According to (6), if the remaining power amount of the battery is equal to or greater than the threshold, the upload of the external environment information is prioritized over the charging of the battery, and thus it is possible to upload the fresh external environment information to the external server. On the other hand, if the remaining power amount of the battery is less than the threshold, the charging of the battery is prioritized over the upload of the external environment information, and thus it is possible to improve convenience for the user who desires to depart immediately after the charging of the battery is completed.

(7) The control device according to (6),

in which the vehicle further includes a notifier (notifier 80) to issue a predetermined notification to a user of the vehicle, and the processor is configured to control the notifier, and

in which the processor controls the notifier to issue a notification prompting power supply continuation if the battery is charged with the power from the power supply facility and the remaining power amount is less than the threshold.

According to (7), when the battery is being charged and the remaining power amount of the battery is less than the threshold, the notification prompting the continuation of the supply of the power is issued, and thus it is possible to prevent the charging from being interrupted in a state where the battery is not sufficiently charged.

(8) The control device according to any of (1) to (7), in which

the processor transmits, to the external server, the external environment information acquired in a parking lot having a parking space where the vehicle is parked.

According to (8), by uploading the external environment information acquired in the parking lot to the external server, the external server can grasp a state in the parking lot based on the external environment information.

(9) The control device according to any of (1) to (7), in which

the processor is configured to acquire vehicle information on the vehicle, and

the memory is configured to further store the vehicle information acquired by the processor, and in which

the processor (vehicle information acquisition unit 33) is configured to transmit information (vehicle information Td2) including the external environment information and the vehicle information to the external server.

According to (9), by uploading the information including the external environment information and the vehicle information to the external server, the external server can grasp the external environment information and the vehicle information based on the information.

(10) The control device according to any of (1) to (7), in which

the memory stores the external environment information and date-and-time information (date-and-time information Td3) in association with each other, the date-and-time information indicating date-and-time when the external environment information is acquired, and

the processor transmits information including the external environment information and the date-and-time information to the external server.

According to (10), by uploading the information including the external environment information and the date-and-time information to the external server, the external server can grasp the external environment information and the date-and-time information based on the information.

(11) A control method for a computer (control device 30) to control a vehicle that includes a motor as a driving source, a battery to supply power to the motor, and a communication interface communicable with an external server, including:

acquiring external environment information around the vehicle;

storing the acquired external environment information in a memory; and

determining, when the vehicle is parked, whether to transmit the external environment information stored in the memory to the external server based on a remaining power amount of the battery, and transmitting the external environment information to the external server by controlling the communication interface based on a result of the determination to, in which

the external environment information is transmitted to the external server when the remaining power amount is equal to or greater than a threshold, and

the external environment information is not transmitted to the external server when the remaining power amount is less than the threshold.

According to (11), when the vehicle is parked, the external environment information is transmitted (that is, uploaded) to the external server on condition that the remaining power amount of the battery is equal to or greater than the threshold. Accordingly, it is possible to prevent occurrence of a situation in which the vehicle cannot travel since the remaining power amount of the battery decreases due to the upload of the external environment information when the remaining power amount of the battery is less than the threshold. Therefore, it is possible to upload the external environment information to the external server while securing power in the battery to such an extent that the vehicle can travel.

(12) A non-transitory computer-readable storage medium storing a program causing a computer to perform processing, the computer configured to control a vehicle that includes a motor as a driving source, a battery to supply power to the motor, and a communication interface communicable with an external server, the processing including:

acquiring external environment information around the vehicle;

storing the acquired external environment information in a memory; and

determining, when the vehicle is parked, whether to transmit the external environment information stored in the memory to the external server based on a remaining power amount of the battery, and transmitting the external environment information to the external server by controlling the communication interface based on a result of the determination to, in which

the external environment information is transmitted to the external server when the remaining power amount is equal to or greater than a threshold, and

the external environment information is not transmitted to the external server when the remaining power amount is less than the threshold.

According to (12), when the vehicle is parked, the external environment information is transmitted (that is, uploaded) to the external server on condition that the remaining power amount of the battery is equal to or greater than the threshold. Accordingly, it is possible to prevent occurrence of a situation in which the vehicle cannot travel since the remaining power amount of the battery decreases due to the upload of the external environment information when the remaining power amount of the battery is less than the threshold. Therefore, it is possible to upload the external environment information to the external server while securing power in the battery to such an extent that the vehicle can travel.

What is claimed is:

1. A control device to control a vehicle that includes a motor as a driving source, a battery to supply power to the motor, and a communication interface communicable with an external server, the control device comprising:
a processor and a memory, wherein
the processor is configured to acquire external environment information around the vehicle,
the memory is configured to store the external environment information acquired by the processor, and
the processor is configured to determine, when the vehicle is parked, whether to transmit the external environment information stored in the memory to the external server based on a remaining power amount of the battery, and to control the communication interface based on a result of the determination to transmit the external environment information to the external server, and wherein
the processor
transmits the external environment information to the external server when the remaining power amount is equal to or greater than a threshold, and
does not transmit the external environment information to the external server when the remaining power amount is less than the threshold.

2. The control device according to claim 1, wherein
the processor is configured to acquire schedule information on a travel schedule of the vehicle, and wherein
the processor
determines whether to transmit the external environment information to the external server based on the remaining power amount and the schedule information acquired by the processor, and
transmits the external environment information to the external server when the remaining power amount is equal to or greater than the threshold and the vehicle is estimated to be parked for a predetermined time or longer.

3. The control device according to claim 2, wherein
the predetermined time is variable according to a data amount of the external environment information to be transmitted to the external server, and
the processor increases the predetermined time as the data amount increases.

4. The control device according to claim 1, wherein
the threshold is variable according to a distance from the vehicle to a predetermined location, and
the processor transmits the external environment information to the external server when the remaining power amount is equal to or greater than the threshold that is an amount required to allow the vehicle to reach the predetermined location.

5. The control device according to claim 4, wherein
the predetermined location is a destination of the vehicle, a home of a user of the vehicle, or a power-suppliable location where a power supply facility enabling power to be supplied to the vehicle is provided.

6. The control device according to claim 1, wherein
when the vehicle is parked and connected to a power supply facility, the processor
transmits the external environment information to the external server and then charges the battery with power from the power supply facility if the remaining power amount is equal to or greater than the threshold, and
charges the battery with the power from the power supply facility and, after the remaining power amount becomes equal to or greater than the threshold, transmits the external environment information to the external server if the remaining power amount is less than the threshold.

7. The control device according to claim 6,
wherein the vehicle further includes a notifier to issue a predetermined notification to a user of the vehicle, and the processor is configured to control the notifier, and
wherein the processor controls the notifier to issue a notification prompting power supply continuation if the battery is charged with the power from the power supply facility and the remaining power amount is less than the threshold.

8. The control device according to claim 1, wherein
the processor transmits, to the external server, the external environment information acquired in a parking lot having a parking space where the vehicle is parked.

9. The control device according to claim 1, wherein
the processor is configured to acquire vehicle information on the vehicle, and
the memory is configured to further store the vehicle information acquired by the processor, and wherein
the processor is configured to transmit information including the external environment information and the vehicle information to the external server.

10. The control device according to claim 1, wherein
the memory stores the external environment information and date-and-time information in association with each other, the date-and-time information indicating date-and-time when the external environment information is acquired, and
the processor transmits information including the external environment information and the date-and-time information to the external server.

11. A control method for a computer to control a vehicle that includes a motor as a driving source, a battery to supply power to the motor, and a communication interface communicable with an external server, comprising:
acquiring external environment information around the vehicle;
storing the acquired external environment information in a memory; and
determining, when the vehicle is parked, whether to transmit the external environment information stored in the memory to the external server based on a remaining power amount of the battery, and transmitting the external environment information to the external server by controlling the communication interface based on a result of the determination to, wherein
the external environment information is transmitted to the external server when the remaining power amount is equal to or greater than a threshold, and
the external environment information is not transmitted to the external server when the remaining power amount is less than the threshold.

12. A non-transitory computer-readable storage medium storing a program causing a computer to perform processing, the computer configured to control a vehicle that includes a motor as a driving source, a battery to supply power to the motor, and a communication interface communicable with an external server, the processing comprising:
acquiring external environment information around the vehicle;
storing the acquired external environment information in a memory; and
determining, when the vehicle is parked, whether to transmit the external environment information stored in the memory to the external server based on a remaining power amount of the battery, and transmitting the external environment information to the external server by controlling the communication interface based on a result of the determination to, wherein
the external environment information is transmitted to the external server when the remaining power amount is equal to or greater than a threshold, and
the external environment information is not transmitted to the external server when the remaining power amount is less than the threshold.
